(19) United States
(12) Patent Application Publication
(10) Pub. No.: US 2017/0356870 A1
(43) Pub. Date: Dec. 14, 2017

(54) REMOTE COMMUNICATION AND POWERING OF SENSORS FOR MONITORING PIPELINES

(71) Applicant: 3M INNOVATIVE PROPERTIES COMPANY, St. Paul, MN (US)

(72) Inventors: Ziyad H. Doany, Austin, TX (US); George D. Kokkosoulis, Cedar Park, TX (US); Mohsen Salehi, Woodbury, MN (US)

(21) Appl. No.: 15/181,558

(22) Filed: Jun. 14, 2016

(51) Int. Cl. G01N 27/20; G01N 17/04; H04B 5/00

(52) U.S. Cl. CPC G01N 27/20; H04B 5/0062; G01N 17/04

(57) ABSTRACT

A remote terminal unit for use in monitoring a metallic pipeline can take an electrical measurement at the pipe and transmit the measurement in a modulated signal to a main measurement unit located along the pipe and distant from the remote terminal unit. The electrical measurement is taken at regular time intervals between a reference electrode electrically connected to the pipe and a coupon composed of a sacrificial corrosion material in order to monitor the pipe for possible corrosion. The electrical measurement is modulated with a low frequency carrier signal for transmission along the pipe, eliminating the need to take the measurements directly at physical locations along the pipe.

### BACKGROUND

Buried metallic pipelines are protected by a coating supplemented with cathodic protection. An impressed current cathodic protection system for a pipeline consists of a DC power source, often an AC powered transformer rectifier, and an anode or array of anodes buried in the ground. The DC power source would have up to 50 amperes and 50 volts, depending upon several factors such as the size of the pipeline and coating quality. The positive DC output terminal would be connected via cables to the anode array, while another cable would connect the negative terminal of the rectifier to the pipeline, preferably through junction boxes to allow measurements to be taken.

Pipelines are also inspected to monitor possible corrosion of them. In particular, test points are placed along the pipeline to allow for pipe-to-soil potential measurement for determining whether the protected metal pipe is corroding or not. These measurements are usually taken at physical locations along the pipeline. As an example, radio systems use UHF and require a surface antenna and a battery to take measurements along the pipeline. These radio systems are more expensive than the users would desire, and hence such systems only cover a small niche of the market where corrosion can be extreme. Also since pipelines are often in harsh and remote environments, obtaining physical access to locations along the pipeline can be challenging and difficult. Accordingly, a need exits for an improved system and method to take measurements along a pipeline or other metallic pipe.

### SUMMARY

A remote terminal unit for use in monitoring a metallic pipe, consistent with the present invention, includes a measurement unit configured to take an electrical measurement between a reference electrode electrically coupled to the pipe and a coupon composed of a sacrificial corrosion material. A control unit is electrically coupled to the measurement unit and configured to receive the electrical measurement from the measurement unit. A communication unit is electrically coupled to the control unit and configured to receive the electrical measurement from the control unit, modulate the electrical measurement with a carrier signal to generate a modulated signal, and transmit the modulated signal on the pipe.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for remote powering and communication of sensors for monitoring pipelines;

FIG. 2 is a block diagram of a main measurement unit for the system; and

FIG. 3 is a block diagram of a remote terminal unit for the system.

### DETAILED DESCRIPTION

Embodiments of the present invention include a remote system for cathodic protection monitoring of protected metallic pipelines, using the pipe itself for communication from a main measurement unit to multiple ultra-low power remote test points with sensors. The measurement data from the remote test points can be used for assessing the corrosive conditions around a pipeline section. The test points can be completely buried and thus away from accidental damage or vandalism. The test points can optionally be equipped with an RFID marker for above ground location and survey at locations along the pipeline.

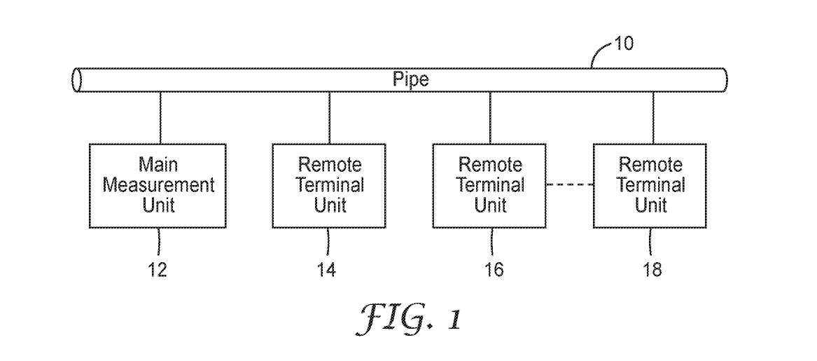

FIG. 1 is a diagram of a system for remote powering and communication of sensors for monitoring a pipe 10 used within a pipeline. The pipeline is typically used to carry oil, natural gas, or water. The monitoring of the pipeline can be used, for example, to detect corrosion, cracks, or defects in the pipeline.

The system includes a main measurement unit 12 electrically coupled to pipe 10 and remote terminal units 14, 16, and 18 electrically coupled to pipe 10 and located remote from each other and main measurement unit 12. Only three remote terminal units are shown for illustrative purposes, and the system can include many remote terminal units depending upon, for example, a length of pipe 10. Remote terminal units 14, 16, and 18 are spaced apart from one another by at least one mile and more typically by at least three to five miles. Remote terminal unit 14 is likewise located at least one mile and more typically at least three to five miles from main measurement unit 12. These distances for the spacing of the remote terminal units are based upon measurements along pipe 10. Remote terminal units 14, 16, and 18 periodically take electrical measurements from pipe 10 and transmit those measurement along pipe 10 along with identifying information such as the physical locations of the corresponding remote terminal unit and a date and time stamp of when the measurements were taken. By transmitting the electrical measurements along the pipe, the system can eliminate the need to access the pipe at the corresponding physical locations for measurements, although the remote terminal units can optionally be accessed at their physical locations in order to obtain the electrical measurements from them.

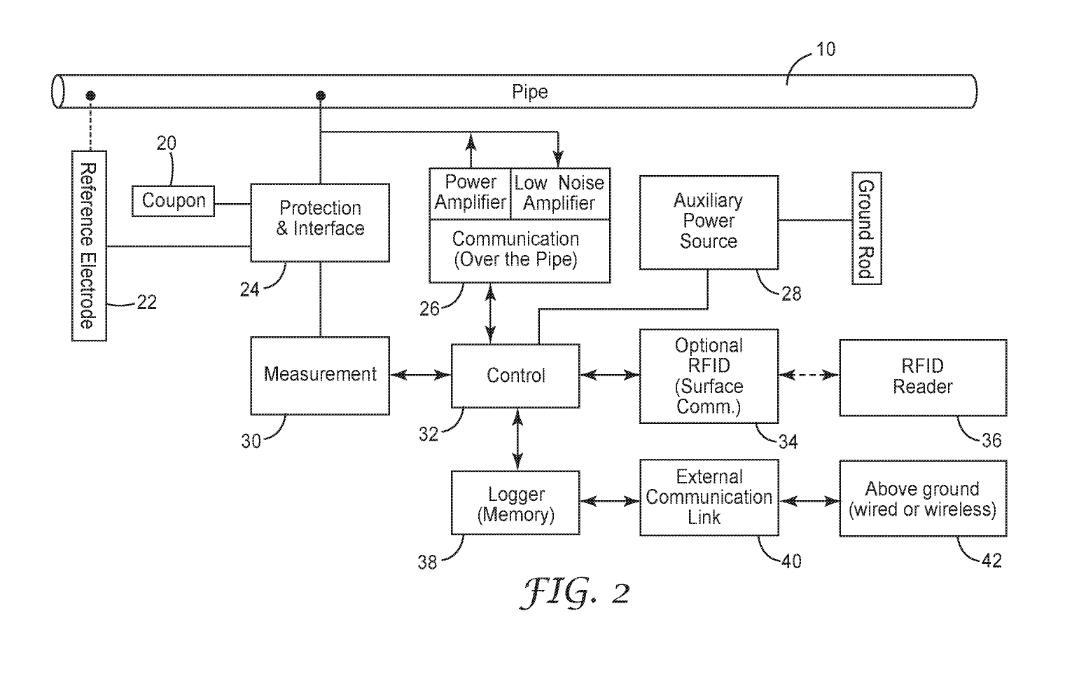

FIG. 2 is a block diagram of main measurement unit 12 for the system. Main measurement unit 12 includes a control unit 32, such as a processor, for controlling operation of main measurement unit 12. Control unit 32 is electrically coupled to a measurement unit 30, a communication unit 26, a logger 38, and an optional radio frequency identification (RFID) tag or marker 34. An auxiliary power source 28, such as a battery, can provide power to control unit 32 and the other components in main measurement unit 12 via control unit 32. Main measurement unit 12 can optionally include a connection to a power source, such as an electrical utility grid, with auxiliary power source 28 providing back-up power.

Measurement unit 30 is electrically coupled to a protection and interface unit 24 to take an electrical measurement between a reference electrode 22 electrically coupled to pipe 10 and a coupon 20 composed of a sacrificial corrosion material, for example a piece of metal similar to the material for pipe 10 and possibly with a corrosion protection coating. Reference electrode 22 can be located on pipe 10 in physical and electrical contact with the pipe. Communication unit 26 can modulate the electrical measurement with a carrier signal and transmit the modulated signal over pipe 10 via a power amplifier. Communication unit 26 can also receive, via a low noise amplifier, electrical measurements in modulated signals transmitted over pipe 10 from the remote terminal units. These received modulated signals are demodulated by communication unit 26 to obtain the electrical measurements.

Control unit 32 stores these electrical measurements in logger 38, such as a non-volatile memory, for access and retrieval. For example, an external communication link 40 is electrically coupled to logger 38 to provide above ground wired or wireless access 42 to the information stored within logger 38. The wired access can include, for example, an above ground electrical connection, such as a universal serial bus (USB), to access logger 38 via a wired connection. The wireless access can include, for example, a short-range wireless connection to logger 38 such as the BUETOOTH technology. In addition, an above ground RFID reader 36 can optionally be used to access the information stored within logger 38 via RFID tag 34 and control unit 32.

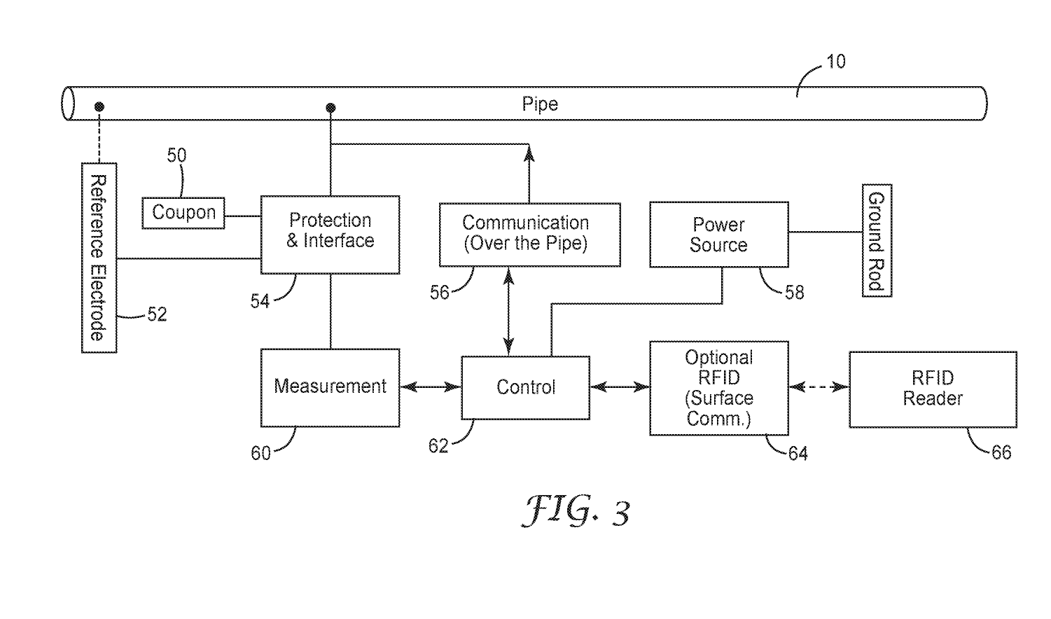

FIG. 3 is a block diagram of a remote terminal unit, such as remote terminal units 14, 16, and 18, for the system. The remote terminal unit includes a control unit 62, such as a processor, for controlling operation of the remote terminal unit. Control unit 62 is electrically coupled to a measurement unit 60, a communication unit 56, and an optional RFID tag or marker 64. A power source 58, such as a battery, provides power to control unit 62 and the other components in the remote terminal unit via control unit 62.

Measurement unit 60 is electrically coupled to a protection and interface unit 54 to take an electrical measurement between a reference electrode 52 electrically coupled to pipe 10 and a coupon 50 composed of a sacrificial corrosion material, for example a piece of metal similar to the material for pipe 10 and possibly with a corrosion protection coating. Reference electrode 52 can be located on pipe 10 in physical and electrical contact with the pipe. Communication unit 56 can modulate the electrical measurement with a carrier signal and transmit the modulated signal over pipe 10. An above ground RFID reader 66 can optionally be used to initiate and obtain the electrical measurement via RFID tag 64 and control unit 62.

For both the main measurement unit and remote terminal units, the corresponding control units 32 and 62 can be programmed to take the electrical measurements at periodic time intervals, for example every three months or every six months. The control units 32 and 62 can also be programmed to initiate the electrical measurement upon receiving a signal from the corresponding RFID readers 36 and 66 via tags 34 and 64, and transmit the measurement to the corresponding RFID reader 36 and 66 via tags 34 and 64. Control units 32 and 62 are preferably implemented with a very low power microcontroller that runs at low voltage. Alternately, the control units can be implemented with programmable logic cells.

The communication units 26 and 56 can be implemented with, for example, circuitry to modulate the electrical measurement with the carrier signal and, in the case of the main measurement unit, also demodulate the received modulated signals. In particular, the communication units preferably comprise an inductor L (1 H) and a capacitor C (5 uF) connected in series to form a resonant LC tank circuit. The remote terminal units obtain their operating voltage and power from this tank circuit but can also modulate the discharge cycle of the tank circuit to communicate back to the main measurement unit.

The electrical measurements are modulated by the corresponding communication units 26 and 56 with a low frequency carrier signal for transmission, for example a 1 KHz signal having an 80% duty cycle. Lower frequencies, less than 1 KHz, can be used and would travel further but would also require larger LC tank circuit components. However, the carrier frequency used should avoid ambient noise caused by the 50/60 Hz power and its low order harmonics, because they may limit the usable dynamic range which reduces the usable distance. For shorter distances, higher frequencies, greater than 1 KHz, can be used. Modulation techniques known for use with RFID systems, for example, can be used to modulate and transmit the electrical measurements.

The remote terminal units transmit the electrical measurements to the main measurement unit when those measurements are taken, as the remote terminal units may not have a logger to store them. The main measurement unit can optionally transmit the electrical measurements taken by it to other main measurement units, if the system has more than one main measurement unit. These low frequency modulated signals can be transmitted along the pipe at least one mile and more typically at least three to five miles along the pipe to a main measurement unit located at those distances from the remote terminal units as measured along the pipe.

Also for both the main measurement unit and remote terminal units, the electrical measurements are taken as an electrical potential difference between the reference electrode and coupon, effectively comparing corrosion between the pipe and the coupon in order to provide an indication of possible corrosion of the pipe. The corresponding measurement units 30 and 60 can be implemented with, for example, circuitry for detecting such a potential difference and outputting a signal relating to the potential difference. The measurement units are preferably implemented with a low power low voltage analog-to-digital (A/D) converter with an interface between the measurement units and the control units.

The corresponding protection and interface units 24 and 54 can be implemented with, for example, circuitry to electrically interface the measurement units with the reference electrodes and coupons and to provide electrical protection for the measurement units. The electrical measurement are typically transmitted with identifying information, also modulated with the carrier signal. The identifying information can include, for example, the following for the corresponding remote terminal unit transmitting the electrical measurement: an identifier for the remote terminal unit; a physical location of the remote terminal unit such as latitude and longitude coordinates or a particular location along the pipe; and a date and time stamp of when the electrical measurement was taken.

Both the main measurement unit and the remote terminal units can be contained within housings for environmental protection. Furthermore, pipelines with cathodic protection already have stations in place for transmitting the power for such protection, and those stations can provide convenient locations for placing the main measurement unit and remote terminal units, although the units can be placed elsewhere along the pipeline as well.

1. A remote terminal unit for use in monitoring a metallic pipe, comprising:
a measurement unit configured to take an electrical measurement between a reference electrode electrically coupled to the pipe and a coupon composed of a sacrificial corrosion material;
a control unit, electrically coupled to the measurement unit, configured to receive the electrical measurement from the measurement unit; and
a communication unit, electrically coupled to the control unit, configured to receive the electrical measurement from the control unit, modulate the electrical measurement with a carrier signal to generate a modulated signal, and transmit the modulated signal on the pipe.

2. The remote terminal unit of claim 1, further comprising a power source electrically coupled to the control unit.

3. The remote terminal unit of claim 1, further comprising an RFID tag electrically coupled to the control unit.

4. The remote terminal unit of claim 1, wherein the measurement unit is configured to measure an electrical potential difference between the reference electrode and the coupon.

5. The remote terminal unit of claim 1, wherein the communication unit is configured to modulate the electrical measurement with a carrier signal having a frequency of 1 KHz.

6. The remote terminal unit of claim 1, wherein the control unit is configured to receive the electrical measurement from the measurement unit at regular time intervals.

7. A system for use in monitoring a metallic pipe, comprising:
a remote terminal unit, comprising:
a first measurement unit configured to take an electrical measurement between a first reference electrode electrically coupled to the pipe and a first coupon composed of a sacrificial corrosion material;
a first control unit, electrically coupled to the first measurement unit, configured to receive the electrical measurement from the first measurement unit; and
a first communication unit, electrically coupled to the first control unit, configured to receive the electrical measurement from the first control unit, modulate the electrical measurement with a carrier signal to generate a modulated signal, and transmit the modulated signal on the pipe; and
a main measurement unit, comprising:
a second control unit having a memory; and
a second communication unit, electrically coupled to the second control unit, configured to receive the modulated signal from the pipe, demodulate the modulated signal to obtain the electrical measurement, and transmit the electrical measurement to the second control unit for storage in the memory.

8. The system of claim 7, further comprising a power source electrically coupled to the first control unit.

9. The system of claim 7, further comprising an RFID tag electrically coupled to the first control unit.

10. The system of claim 7, wherein the first measurement unit is configured to measure an electrical potential difference between the reference electrode and the coupon.

11. The system of claim 7, wherein the first communication unit is configured to modulate the electrical measurement with a carrier signal having a frequency of 1 KHz.

12. The system of claim 7, wherein the first control unit is configured to receive the electrical measurement from the first measurement unit at regular time intervals.

13. The system of claim 7, wherein the first communication unit is configured to transmit the modulated signal to the main measurement unit at regular time intervals.

14. The system of claim 7, wherein the remote terminal unit is spaced apart from the main measurement unit by at least one mile along the pipe.

15. The system of claim 7, wherein the main measurement unit includes an external communication link for providing access to the electrical measurement from the memory.

16. The system of claim 7, wherein the main measurement unit includes a second measurement unit, electrically coupled to the second control unit, configured to take another electrical measurement between a second reference electrode electrically coupled to the pipe and a second coupon composed of a sacrificial corrosion material and transmit the another electrical measurement to the second control unit for storage in the memory.

17. The system of claim 16, wherein the second measurement unit is configured to measure an electrical potential difference between the second reference electrode and the second coupon.

18. The system of claim 7, further comprising a power source electrically coupled to the second control unit.

19. The system of claim 7, further comprising an RFID tag electrically coupled to the second control unit.
